(19) United States
(12) Patent Application Publication
(10) Pub. No.: US 2008/0085761 A1
(43) Pub. Date: Apr. 10, 2008

(54) System and method of conducting game show and interactive gaming implementing the same

(76) Inventor: Ross K. Bagwell, Knoxville, TN (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/902,801

(22) Filed: Sep. 25, 2007

Related U.S. Application Data
(60) Provisional application No. 60/846,761, filed on Sep. 25, 2006.

(51) Int. Cl. A63F 13/00; A63F 9/24

(52) U.S. Cl. 463/22; 463/16; 463/39; 463/40

(57) ABSTRACT

A system and method are provided for conducting a game show which is adopted to be presented as a televised game show, a promotional game on a touch-screen computer monitor, or an interactive floor game. Game includes a floor grid and a spinning wheel. Grid can be computer-controlled, interactive floor made up of 10 rows each having 10 squares numbered 1-100 and programmed with lights and sound. Wheel contains numbered spaces from zero to 10 with one being omitted. The object of the game is to successfully progress through all ten rows on the grid, each of the rows having a cash prize associated therewith. When contestant begins the game, all 100 squares on the grid appear yellow, and the contestant picks a square on the first row at random and step on it causing that square to lights up either green or red. If it is green, the contestant wins the prize for that row and is allowed to move on in the game. If it is red, the contestant loses all of the money and forfeits the turn. As contestant progresses from one row to the next, the cash prizes increase, as well the number of red squares than the early rows. At each turn, we the contestant is informed as to how many squares are red and how many are green in the next row. At any point in the game, the contestant has an option to quit by spinning the wheel. The number on the wheel where the wheel stops when spun is multiplied by the total amount of money the contestant is a assigned on the present row. If the wheel stops on a zero, the contestant looses all of the assigned money and forfeits the turn.

This application claims benefit under 35 U.S.C. § 119(e) from U.S. Provisional Patent Application Ser. No. 60/846,761 filed on Sep. 25, 2006, the entire content of which is incorporated herein by reference.

### BACKGROUND OF THE INVENTION

1. Field of Invention

The present invention relates to system and method of conducting a game show which is adopted to be presented as a televised game show, a promotional game on a touch-screen computer monitor, or an interactive floor game.

2. Description of Related Art

The popularity of televised game shows and interactive promotional games continues to grow in the United States and many countries around the world. Recent additions to television game lineup include a number of games which require contestants to undertake extraordinary measures both physical (such are ingesting cockroaches) and mental (such as knowing authors of obscure literary works) in order to achieve the goal of winning the contest.

At the same time, game shows which require little skill in order to achieve substantial monetary rewards have also been gaining popularity. When asked about the success of NBC's breakout hit, Deal or No Deal, Executive Producer Scott St. John had this to say: “It's a game that requires no skill . . . I don't have to be a genius, and I don't have to eat a bug to play. I can be anyone in the world and play this game and win a ton of money.” This ushers in a new generation of game shows, one where formats have been stripped down to their basic essence: the player versus the odds.

### SUMMARY OF THE INVENTION

Exemplary embodiments of the present invention provide a game show which does not require contestants to have a high level of skill, while presenting the contestants with a high stakes game of chance. A system and method are provided which incorporate a level of simplicity required to participate and compete in the game. Other than decision making ability, one of the few skills needed to play the game is indicating a choice of, for example, next object.

In an exemplary implementation of the present invention, system and method include providing a game where the object of the game is to successfully progress through all rows (for example, 10 rows of squares) on a grid (for example, 10 rows by 10 columns of squares), each of the rows having a cash prize associated therewith. When contestant begins the game, all the squares on the grid appear yellow. The contestant picks, or is directed to, a square on a row one at random, and then step on the square. Once the contestant steps on that square, an indication is given (for example, the square either lights up green or red) such that, for example, if the square lights up green, the contestant wins the prize for that row and is allowed to move on in the game, and if the square lights up red, the contestant loses all of the money assigned up to that point in the game and the contestant's turn ends.

In an exemplary implementation of the present invention, as the contestant progresses from one row to the next, the cash prizes increase. Also, the chance of losing the assigned prize money also increases (for example, the later rows may have more red squares than the prior rows), giving the contestant a greater chance of losing all of the money. At each turn, the contestant may be informed at to the contestant's odds of success or failure (for example, by informing the contestant how many squares are red and how many are green).

In an exemplary implementation of the present invention, the contestant has the option to quit at any point in the game by, for example, choosing to spin a wheel where all of the numbers on the wheel are multipliers such that the number where the wheel stops is multiplied by the amount of contestant's prize money won up to that point.

In an exemplary implementation of the present invention, one of the multipliers on the wheel is zero, whereby if the wheel stops on the zero multiplier, the contestant loses the prize money.

According to an exemplary embodiment of the present invention, the choosing option can be implemented by a flat surface where a contestant places a foot, or steps, onto a desired location such as a square in a row of squares.

According to another exemplary embodiment, the choosing option can be implemented by means of a touch screen.

According to yet another exemplary embodiment of the present invention, the choosing option can be implemented in conjunction with, for example, spinning of a wheel to determine, for example, a level of prizes available to the contestant.

Exemplary implementations of the embodiments of the present invention include, but are not limited to, television game show, interactive computer programs, promotional events, on-line gaming, and the like.

### BRIEF DESCRIPTION OF THE DRAWINGS

The various objects, advantages and novel features of the present invention will be best understood by reference to the detailed description of the preferred embodiments which follows, when read in conjunction with the accompanying drawings in which the same reference numerals will be understood to refer to the same elements, features, and structures, where:

FIG. 1 illustrates an exemplary implementation of a wheel according to an embodiment of the present invention.

FIG. 2 illustrates an exemplary implementation of a grid according to an embodiment of the present invention.

FIG. 3 illustrates an exemplary implementation of game participation according to an embodiment of the present invention.

FIG. 4 illustrates an exemplary implementation of row values assigned to a grid according to an embodiment of the present invention.

FIG. 5 illustrates an exemplary implementation of success and failure locations assigned to a grid according to an embodiment of the present invention.

FIG. 6 illustrates an exemplary implementation of statistics associated with a game according to an embodiment of the present invention.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Exemplary embodiments of the present invention will now be described in detail with reference to the annexed drawings. In the following description, a detailed description of known functions and configurations incorporated herein has been omitted for clarity and conciseness.

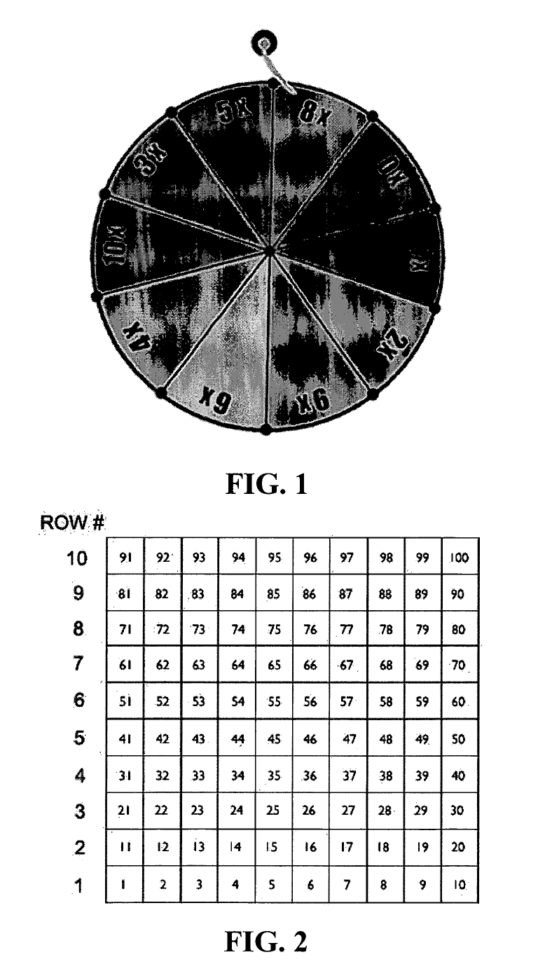

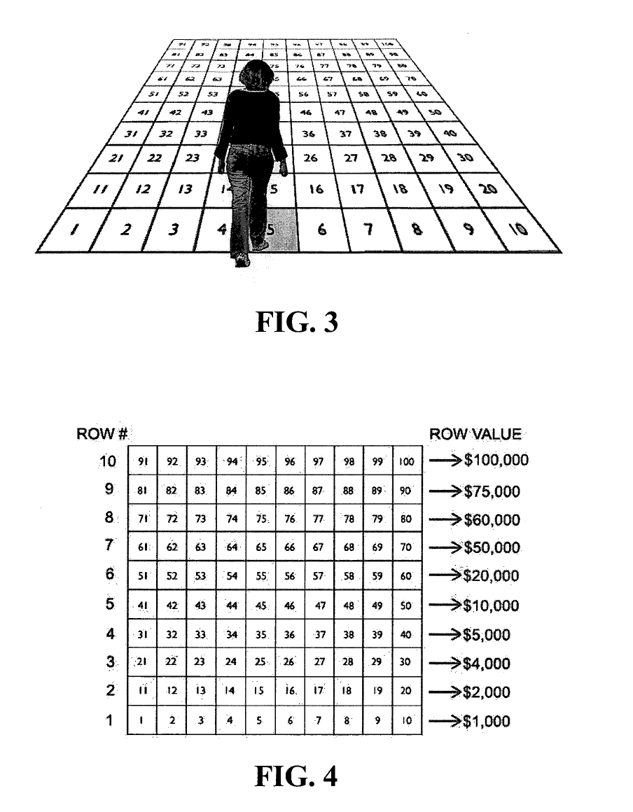

Referring to FIG. 3, in an exemplary implementation of an embodiment of the present invention, contestant 24 must get across a grid 20 of, for example 100 individual squares 22 one row at a time. Each time the contestant 24 takes a step, the square 26 under the contestant 24 will either light up green or red. If it's green, the contestant 24 wins a cash prize and get to move on to the next row 28 of squares. If it's red, the contestant 24 loses and the game is terminated. At any point during the game, the contestant 24 is given an option to quit by spinning a wheel 10 comprising, for example 10 sections 12 each having a different multiplier 14 indicated thereon, as shown in FIG. 1, and multiplying amount of the contestant 24 cash prize by the multiplier shown in that of sections 12 which lands on the indicator 16.

This exemplary implementation can be televised or experienced live, and offers television viewers, audience and contestants various stimuli associated with a modern game show, including but not limited to suspense, drama and simplicity. An exemplary advantage of the above-described implementation facilitates viewer's vicarious participation in the game while observing the contestants either live or via television program.

In an exemplary implementation of the present invention, as shown in FIGS. 1 and 2, the game comprises two major components: a floor grid 20 and a spinning wheel 10. The grid 20 can be implemented as a computer-controlled, interactive floor made up of 10 rows 28 each row comprising 10 squares 22. The squares 22 can be programmed with lights (not shown) and/or sounds. These squares 22 can be numbered, for example from 1 to 100, consecutively. The second component, the wheel 10, can contain, for example 10, spaces 12 which can be numbered 14. In an exemplary implementation, the spaces 12 can be numbered from zero to 10 (with the number one being omitted) where the numbers 14 serve as prize amount multipliers.

In an exemplary implementation of the present invention, the object of the game is for contestant 24 to successfully progress through all ten rows 28 on the grid 20, where each of the rows has a cash prize 40 (see FIG. 4) associated therewith. When contestant 24 begins the game, all 100 squares 22 on the grid 100 appear yellow. The contestant 24 is instructed to choose a square on a first row at random and step on it, as shown in the example of FIG. 3 where contestant 24 chooses fifth square 22 of the first row 28. As further illustrated in FIG. 3, once the contestant steps on the chosen square 22, the square lights up either green or red. If it's green, the contestant wins the prize 40 associated with that row and is allowed to move on in the game, for example to choose a square in the next row. If the square 22 stepped on by the contestant 24 lights up red, the contestant 24 loses the prize and the contestant's turn is forfeited.

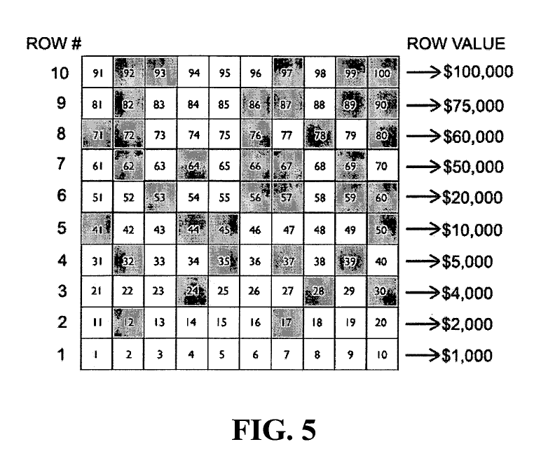

In an exemplary implementation, as the contestant progresses from one row to the next, the cash prizes increase (as shown in FIG. 4). On the other hand, in an exemplary implementation of the present invention, the later rows 28 may have progressively greater number 50 of red squares 52 than the early rows 28 (as shown in FIG. 5), whereby the contestant 24 gas a greater chance of losing the prizes and forfeits the turn. At each turn, the contestant may be informed as to exactly how many squares are red 52 and how many are green 54 so that the contestant can estimate the odds of success or failure.

In an exemplary implementation, at any point in the game, the contestant 24 has the option to quit the game. In order to quit the game, the contestant 24 may be required to spin the wheel 10 which contains prize multipliers 14 in sections 12 thereof (as shown in FIG. 1). When the contestant spins the wheel 10, the number that the wheel stops on, as indicated by the indicator 16 is multiplied by the total amount of money, as calculated based on the value 40 associated with the row where the contestant is located at the point when the contestant chooses to quit the game. For example, if the contestant is located in row #4, which has a value of $5,000 associated therewith, and the wheel is spun such that the indicator 16 indicated section 12 having a multiplier 14 of value “7X”, then the contestant wins $35,000. In an exemplary embodiment, one of the multiplier can have a value of “0X”, so that then when the wheel stops such that the indicator 16 is in the section 12 having the “0X” multiplier, the contestant looses the prize money and forfeits the turn.

Exemplary scenarios associated with certain embodiments of the present invention are described below.

For example, if a contestant has made it through three rows. That means the contestant has earned $4,000. In this example, the cash prizes for each row are non-cumulative. On the fourth row, the contestant may again step on a “green” square, putting the contestant's new total at $5,000. Next, the contestant is given an option to move on to the next row or quit and spin the wheel. If the contestant decides to spin the wheel and the wheel stops on multiplier “8X”, the contestant wins $40,000 and the contestant's turn ends. If the contestant successfully reaches row 10 by stepping on only “green” squares in each of the 10 rows, the contestant wins the $100,000 prize. Then the contestant can be given an option to either take the $100,000 or spin the wheel for a chance to win $1,000,000. In the case of one of the wheel's multipliers being “0X”, if the wheel stops on the “0X” multiplier, the contestant loses all of the prize money.

One of ordinary skill in the art would readily appreciate that other scenarios are possible without departing from the spirit and scope of the present invention. For example, the cash prizes when progressing from one row to the next can be cumulative (for example, when reaching the third row, contestant would have accumulated $1,000+$2,000+$4,000=$7,000).

In an exemplary implementation of a television game show, the number of contestants sequentially participating in the game can vary depending on the duration of the show, and the length of time that each contestant participates in the game before loosing the turn. If the last contestant doesn't finish the turn before the end of the episode, the game can be continued in the next episode. In an exemplary implementation, in every new game, the configuration of red and green squares will be different. This uniqueness of the configuration can be verified by an independent third party.

As explained below, the appeal and other exemplary advantages of certain exemplary embodiments of the present invention are based on a notion of a game of chance stripped down to its very essence. And while the exemplary implementation of the game according to the present invention are novel, the playing and viewing experience may feel oddly familiar to viewers on a subconscious level. That is because, for example, exemplary embodiments of the present invention provide a game which implements a unique combination of two of the more familiar elements of a game: a board and a wheel. In an exemplary configuration the game may be considers as a giant board game where the people are the game pieces, money is won both by advancing on the board and by spinning the wheel. The game may also play on viewers' and participant's notions of color, which have been ingrained into a human collective psyche since childhood. For example, majority of people instantly associates red with stop and green with go. These color schemes are reinforced in daily lives in everything from traffic lights, to buttons, to signs.

In contrast to other conventional game shown, an exemplary implementation of the game according to the present invention can be simplified by, for example, avoiding such contrivances as lifelines, tribal councils, bankers, and audience votes. In an exemplary implementation, the participants are facilitated to focus on the emotional battle that may take place when a contestant is faced with the choice of taking the money and spinning the multiplier wheel, or risking the prize on the next step.

In an exemplary implementation of a television game show according to the present invention, a host can be included as part of the game. A host should be likeable by the viewers and participants of the game, someone who is able to put a contestant at ease and get the contestant to talk about the decision at hand. One of the primary functions of the host can be to draw out the internal conflict of a contestant facing the next option of the game. For example, as a contestant deliberates on whether to take the prize associated with the present row or to move on to the next row, the host may talk the contestant through the decision process, allowing the contestant to explain the decisions for the benefit of the viewers. The host may also discuss the risks associated with the options available to the contestant.

In an exemplary implementation of the present invention, the game can be played on a dark stage with dramatic lighting. The host and contestant may be allowed to move freely around the set of the game show. Once a contestant decides to move on to the next row, the contestant may be allowed to pace back and forth on the current row while deciding which square to choose on the next row. Throughout the decision process, the host may talk to the contestant regarding the decision.

In an exemplary implementation of the present invention, once the contestant decides to take a step, a camera mounted directly overhead may show viewers a full view of the board. The viewers may also be shown an overlay of the row where the contestant is about to take a step, which shows which squares are red and which are green. Such an overlay would not be seen on the studio monitors—just by remote television viewers, for example on a viewer's home television monitor.

In an exemplary implementation of the present invention, in addition to the cash prizes, “special instant prizes” may be included. Such non-cash prizes can be “hidden” in various squares 22 across the grid 10, and may include but not be limited to, a camera, a vacation package, a new car, and the like. If a contestant wins an instant prize, the contestant my be allowed to keep it whether or not the contestant steps on a red square or if the wheel lands on zero multiplier “0X”. Viewers at remote location may also be involved in the game by allowing the viewers to call a designated phone number and to choose one of the 100 numbers on the grid. If the number chosen by the remote viewer is the winning number for the day, the callers who chose that number may be given the opportunity to win a prize.

In addition to a television show implementation, certain embodiments of the present invention may be implemented in a broad spectrum of other game-related mediums from low-tech board games to state-of-the-art touch-screen gaming.

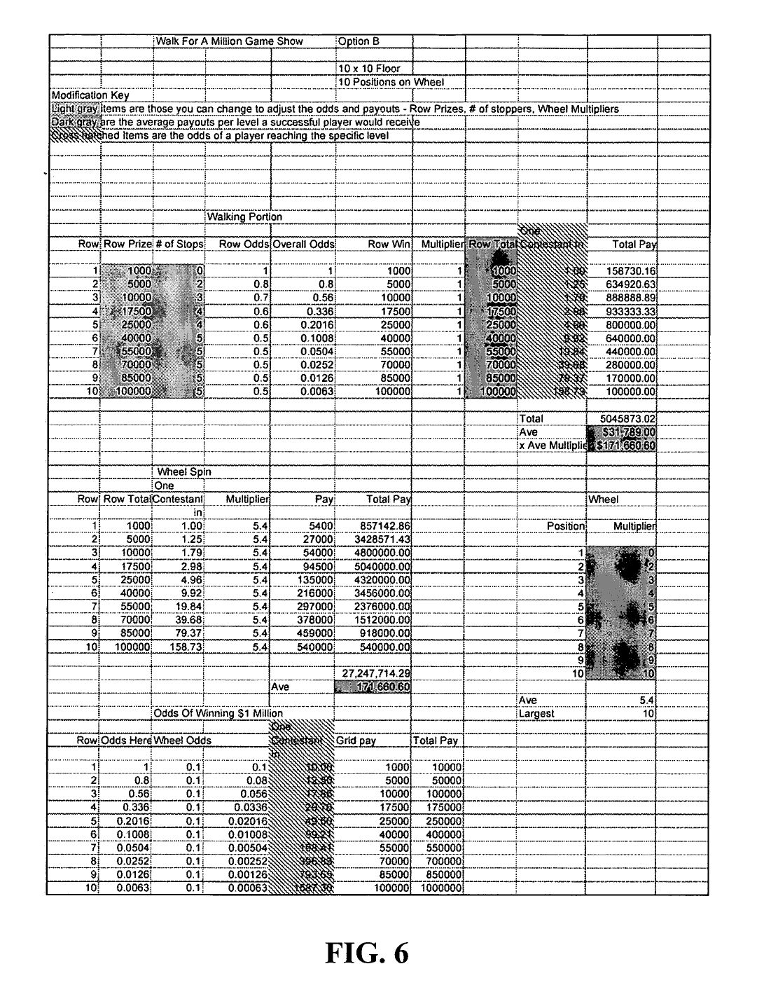

According to exemplary implementations of the embodiments of the present invention, the odds of winning can be facilitated as shown in the table of FIG. 6. For example, values of row prizes 40, number of red squares 52 and multipliers 14 can be varied to adjust the odds of wining and payout amount. In the example of FIG. 6, the average payouts per level that a winning contestant would receive is $31,789.00 with the average multiplier increasing that value to $171,660.60. In the example of FIG. 6, the odds of a contestant reaching rows 1, 2, 3, 4, 5, 6, 7, 8, 9 and 10 are one in 1.00, 1.25, 1.79, 2.98, 4.96, 9.92, 19.84, 39.68, 79.37 and 158.73, respectively. In the example of FIG. 6, the combined odd of winning based on the row reached and spinning of the wheel are shown in the “Odds of Winning $1 Million” section.

While the invention has been shown and described with reference to a certain exemplary embodiment thereof, it will be understood by those skilled in the art that various changes in form and details may be made therein without departing from the spirit and scope of the invention as defined by the appended claims and the full scope of equivalents thereof.

1. A gaming system comprising:
a grid comprising a plurality rows, each of the rows comprising a plurality of individually selectable locations and a row value associated therewith; and
an interactive multiplier comprising a plurality of multiplier values;
wherein each of the locations comprise one of a success and a failure conditions assigned thereto, and a game participation comprises selection of one of the locations;
if selection of one of the locations in a current row of the plurality of rows causes the success condition, selection in a subsequent row of the plurality of rows is enabled, the row value associated with the current row is assigned, and access to the interactive multiplier is enabled;
if the access to the interactive multiplier is enabled and selected, a chosen value of the plurality of the multiplier values is assigned, whereby a total value is assigned, the total value being equal to the product of the chosen value of the plurality of the multiplier values and the row value associated with the current row; and
if the selection of the one of the locations in the current row of the plurality of rows causes the failure condition, the game participation is terminated.

2. An interactive computer game system comprising the gaming system of claim 1.

3. An interactive television game show comprising the gaming system of claim 1.

4. A method of conducting a game comprising:
providing a grid comprising a plurality rows, each of the rows comprising a plurality of individually selectable locations and a row value associated therewith, wherein each of the locations comprise one of a success and a failure conditions assigned thereto, and a game participation comprises selection of one of the locations;
providing an interactive multiplier comprising a plurality of multiplier values;
if selection of one of the locations in a current row of the plurality of rows causes the success condition, enabling selection in a subsequent row of the plurality of rows, assigning the row value associated with the current row, and enabling access to the interactive multiplier;
if the access to the interactive multiplier is enabled and selected, assigning a chosen value of the plurality of the multiplier values, whereby a total value is assigned, the total value being equal to the product of the chosen value of the plurality of the multiplier values and the row value associated with the current row; and
if the selection of the one of the locations in the current row of the plurality of rows causes the failure condition, terminating the game participation.
